(19) United States
(12) Patent Application Publication
(10) Pub. No.: US 2014/0028474 A1
(43) Pub. Date: Jan. 30, 2014

(54) PERIMETER BREACH ALARM SYSTEMS

(71) Applicants: Roger Poeth, Nottinghamshire (GB); James Jarrett, Leicestershire (GB)

(72) Inventors: Roger Poeth, Nottinghamshire (GB); James Jarrett, Leicestershire (GB)

(73) Assignee: HIGHWAY RESOURCE SOLUTIONS LTD., London (GB)

(21) Appl. No.: 14/110,521

(22) PCT Filed: Mar. 30, 2012
(86) PCT No.: PCT/GB12/50733

§ 371 Date: Oct. 8, 2013

(30) Foreign Application Priority Data
Apr. 8, 2011 (GB) 1106031.6
Apr. 18, 2011 (GB) 1106533.1
Aug. 30, 2011 (GB) 1114935.8
Dec. 10, 2011 (GB) 1121808.8

(51) Int. Cl. G08G 1/01

(52) U.S. Cl. CPC G08G 1/01
USPC 340/908.1

(57) ABSTRACT

A system in which a sensor unit in the casing of a lantern detects an impact and generates a wireless alert signal and is powered from the battery used to power the light source of the lantern. The sensor unit can be mounted onto the terminals of a battery and held within the cavity of the lantern housing used to house the battery. In this way the sensor unit can be incorporated with the lantern without any modification to the design of the lantern.

### BACKGROUND

The present invention relates to a perimeter breach alarm system and a method of constructing such as system. It also relates to a lantern which sits on or is used in conjunction with road markers, and in particular the adaptation of said lanterns for use in a perimeter breach/collision warning system.

Traffic cones or equivalent road marking/barrier elements are frequently used to close off and redirect traffic from areas of a thoroughfare requiring maintenance. A vehicle carrying stacked nested cones is driven slowly along a route where the cones are to be laid, and a road worker walking with the lorry distributes the cones from the lorry onto the road as required. In order that the cones are visible at night, some or all of the cones are provided with a lantern adapted to sit on top of the cone and to emit a light. The lanterns are usually mounted on the cones after the cones have been deposited onto the road, and are removed before the cones are stacked back on the lorry.

Although cones with lanterns form a conspicuous boundary, they provide an ineffective physical obstruction to a vehicle travelling at speed. This has prompted the development of various systems to warn road maintenance workers when a vehicle breaches a cone perimeter. Most of these systems include a sensing means to detect that a vehicle has breached the cone perimeter and an audible alarm to warn the road workers. One such system comprises a sensing means associated with each cone, the sensing means functions to detect that a cone has been knocked over and in consequence thereof, to emit a signal to activate an alarm remote from the cone. Examples of prior art systems are disclosed in GB2465214; FR2886952; U.S. Pat. No. 6,288,651; U.S. Pat. No. 7,030,777; US2005/027019; US2007/0223996 & WO03/080937.

Notwithstanding the potential benefit of such systems, they have not been widely adopted.

Once a breach has occurred it is necessary for the cones to be reinstated as stray cones and gaps in the perimeter, especially at tapers, constitute safety hazards. To ensure the cone perimeters remain intact, it is common for regular patrols of the perimeters to be conducted.

### BRIEF SUMMARY

The present developments came about from seeking to improve current systems, and to allow them to be implemented without the need for companies who provide the cones, lantern and batteries, to replace existing equipment.

According to a first aspect of the invention there is provided a lantern comprising a light source, a sensor to detect an impact with a vehicle, and signal generating means for generating an alarm signal in response to a detected impact.

By incorporating the sensor and signal generating means with the lantern, it is possible to use the battery of the lantern to power the sensor, thereby doing away with the need to provide an additional power source. It also removes the need to provide the sensor and signal generating means with its own weatherproof housing.

In one preferred embodiment, a sensor unit comprising the sensor and signal generating means, and which is arranged to draw power from the battery, is located within a cavity defined by the lantern for housing the battery. Favorably, the sensor unit is interposed in a space between the battery and the cavity wall which accommodates the battery terminals/the lantern's electrical contacts to the battery which usually extend away from the battery body and/or cavity wall. Additionally, this positioning favorably allows the sensor unit to be supported in electrical contact with the battery either through direct contact with the terminals or electrical contacts. Through the above arrangement, it is possible to incorporate the sensor unit into the lantern simply by accessing the battery cavity of the lantern and requires no changes to be made to the design of lantern or choice of battery.

The sensor unit may comprise an aperture or recess through which at least one terminal of the battery or the conducting means to the battery extend.

The sensor unit's electrical contacts may be arranged adjacent to the aperture so as to make electrical contact with the terminal of the battery passing through the aperture. This allows the sensor unit to be powered by the battery without the need for additional wires, which would need to be housed, could become tangled with the terminal of the battery (especially when in the form of a coil), or could interfere with the connection between the battery and the lantern's connectors.

To maximize the contact between the terminals of the battery and the electrical contacts of the sensor unit, it is preferred that the electrical contacts of the sensor unit are arranged on either side of the aperture, and may also be provided on both opposing faces of the sensor unit.

The sensor unit is preferably mounted to the terminals of the battery as this makes the sensor unit easy to install into the lantern. Where the terminals comprise coil springs, the sensor unit is preferably mounted onto the springs such as to cause a slight extension of the coils. The coils respond by compressing against the sensor unit, thereby supporting the sensor unit to the battery and ensuring the electrical contact between the terminals of the battery and the electrical connectors of the sensor unit is maintained.

In order that the sensor unit may be easily mounted onto the battery's terminals, the sensor unit may comprise one or more slots which extend inwardly from an outer edge of the sensor unit. Preferably the sensor unit comprises one slot through which both battery terminals extend. A slot extending diagonally inwards from an outer corner edge of the sensor unit is preferred.

It is preferred that the sensor unit is sized to sit within the ‘footprint’ area of the end face of the battery carrying the terminals.

It is favorable that the lantern is adapted to be supported on a traffic cone.

It is generally favored that the sensor unit will produce the alarm signal by a wireless transmission in the radio or microwave frequency.

The sensor of the sensor unit is favorably an accelerometer which, when installed in the lantern, senses when the lantern has been impacted, tipped, or knocked over in a manner consistent with an impact from a vehicle and produces a signal indicative thereof.

According to a second aspect of the invention there is provided a perimeter breach alarm system comprising multiple sensor units located at positions along a perimeter; each sensor unit having a sensor to detect when the perimeter proximate that sensor unit has been breached and to produce a signal indicative thereof; means to receive the signal from the sensor and to generate a wireless alarm signal; and
an alarm unit adapted to receive the wireless alarm signal from one or more of the sensor units and in response to receiving the wireless alarm signal, to produce an audible or visual alarm.

Preferably the sensor units are also provided with means to relay wireless alarm signals from neighboring sensor units. In this way it is possible to provide the sensor units with relatively low power transmitters, thereby reducing power consumption.

Preferably, the system also comprises a long range transmitter unit, as compared to the sensor units, arranged to transmit a signal upon receipt of the alarm signal from a sensor unit. This long range transmission signal may be used to provide a warning to persons remote of the perimeter that cones have been knocked over, so that a response team can be sent.

In a preferable embodiment, the long range transmitter is incorporated with the alarm unit.

In such a embodiment it is preferred that each sensor unit is provided with a unique identifier and/or position information pertaining to its location about the perimeter and sends the unique identifier and/or position information in response to a detected breach. The long range transmitter unit may be arranged to transmit identifier and/or position information of the sensor unit which has emitted the alarm signal.

Additionally or alternatively the long range transmitter may be arranged to transmit identifying/positional information of the alarm unit which received the alarm signal.

According to a third aspect of the invention there is provided a method of constructing a perimeter breach alarm system comprising: deploying a number of discreet sensor units at positions along a perimeter, each sensor unit comprising: a sensor to detect when a portion of the perimeter proximate the unit has been breached and a signal generating means to generate an alarm signal in response to a detected breach; moving a location unit between the sensor units; using means associated with the location unit to obtain position information of the location unit: storing and associating the position information with a proximate sensor unit.

Through employment of the third aspect of the invention, it is possible to provide each sensor unit with its approximate location without the need to provide each sensor unit with a satellite navigational system receiver, reducing the cost of the sensor units. Although this leaves the possibility that the position information may not be as accurate compared a system in which each sensor unit has its own satellite navigational system receiver, this is not expected to be of a concern as an approximate position will be sufficient where there are long stretches, e.g. several kilometers of cones, or where there are a number of different cone perimeters in different locations.

Knowing the approximate position of each sensor unit allows the position of any breach to be quickly identified.

In a preferred embodiment, the location unit transmits the position information to the sensor unit which stores it in a store. The position information can be transmitted by the means to generate an alarm signal in response to a detected breach.

Alternatively or in addition, the position information can be held elsewhere, e.g. in the location unit and/or at a place remote from the perimeter. In such instances the store may hold a number of records, each record comprising the position information and an identifier of the associated sensor unit. The identifier may be transmitted by the sensor unit to the location unit when the sensor unit is being deployed, or may be generated by the location unit itself, e.g. in response to receiving a signal from a sensor unit being deployed.

It is preferable that the perimeter breach alarm system comprises an alarm unit which is remote from the sensor units and is arranged to receive the alarm signal from a sensor unit and to activate an alarm, e.g. a horn/siren or visual warning. Preferably the location unit is incorporated with the alarm unit to form a single unit. Where this is so, it is preferable that the combined unit comprises a switch to enable the combined unit to switch between operation modes when the sensor units are being provided with or associated with position information, and another in which the combined unit is responsive to alert signal transmitted from the sensor units.

Where the system is used with a cone barrier on a roadway, it is generally expected that the sensor units will be incorporated into lanterns which may sit onto or nearby the cones.

It has been realized that the arrangement of the sensor units could be used as a communications network and therefore in accordance with a further aspect of the invention there is provided a method of transmitting data between a first unit and a second unit spaced remotely at positions about a boundary perimeter, comprising: providing a perimeter breach alarm system comprising multiple sensor units spaced about the perimeter, each sensor unit comprising: a sensor for detecting that the perimeter proximate the sensor unit has been breached and signal generation means responsive upon said detection to transmit an alert signal; transmitting the data from the first unit to a sensor unit which is proximate the first unit; relaying the data between sensor units along the perimeter; and transmitting the relayed data from a sensor unit to the second unit.

It is preferred that the sensor unit proximate the first unit relays the data together with auxiliary information pertaining to the proximate sensor units identity and/or position; and that the sensor units along the perimeter relay the data and the auxiliary information from the proximate sensor unit. In this way it is possible for the second unit to estimate the position of the first unit about the perimeter.

According to a further aspect of the invention there is provided a sensor unit for use in the lantern comprising a sensor for detecting when the lantern has been impacted, signal generation means responsive upon detection that the lantern has been impacted or tipped and to transmit an alert signal; wherein the body of the sensor unit is provided with an aperture/recess through which a terminal of a battery can pass; and electrical contacts adjacent the aperture to provide electrical connection between the sensor unit and the battery terminal. It is preferred that the aperture/recess comprises a slot which extends inwardly from an outer edge of the sensor unit.

### BRIEF DESCRIPTION OF THE DRAWINGS

The invention will now be described by way of example with reference to the following figures in which:

FIG. 1 is an exploded perspective view of a lantern, battery and sensor unit forming part of a collision warning system;

FIG. 2 is an exploded perspective of the components of FIG. 1 looking upwardly to illustrate the underside of the sensor unit;

FIG. 3 is an exploded perspective of the components of FIGS. 1 & 2 illustrating the conductor means of the lantern;

FIG. 4 is a perspective (part schematic) cross section of the components assembled;

FIG. 5 is a perspective view of the battery and sensor unit with the sensor unit ready to be installed on the battery;

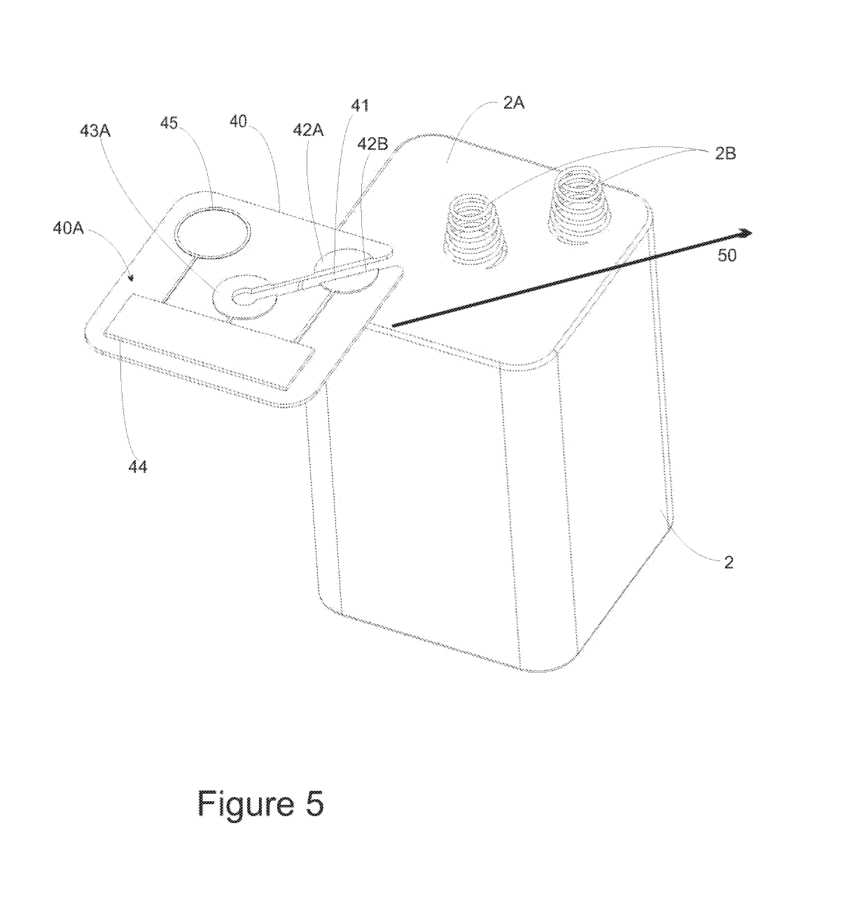

FIG. 6 is a perspective view of the sensor unit installed on the battery;

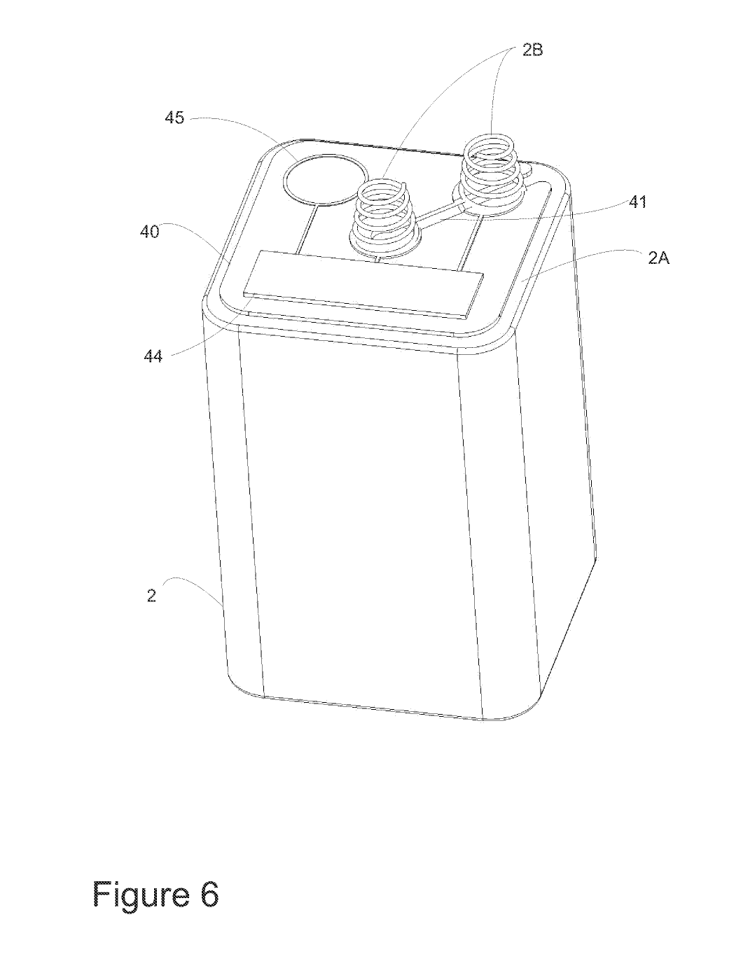

FIG. 7 is a schematic representation of components of a barrier breach warning system of which the sensor unit forms a part;

FIGS. 8A-8C are plan views of a carriageway partially closed off with a cone barrier equipped with a barrier breach alarm system in various stages of installation;

FIG. 9 is a schematic representation illustrating the barrier breach warning system of FIG. 8;

FIG. 10 is a plan schematic view of a barrier which has been breached, illustrating the relay function of the sensor units; and

FIG. 11 is a plan schematic view of a barrier breach warning system being used as a data channel between units not forming part of the barrier breach warning system.

### DETAILED DESCRIPTION

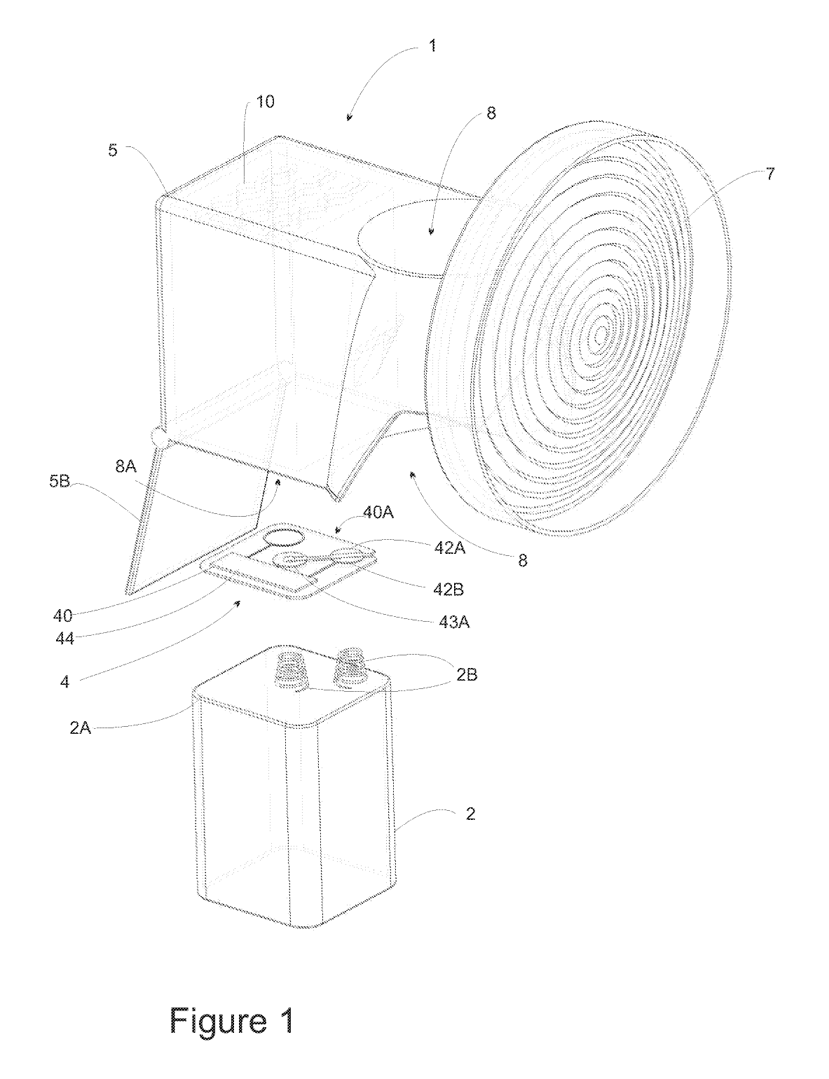

Referring to FIGS. 1 to 4 there is illustrated a lantern 1, a lantern battery 2 having a top surface 2A supporting two projecting spring coil terminals 2B; and a sensor unit 4 comprising a circuit board 40.

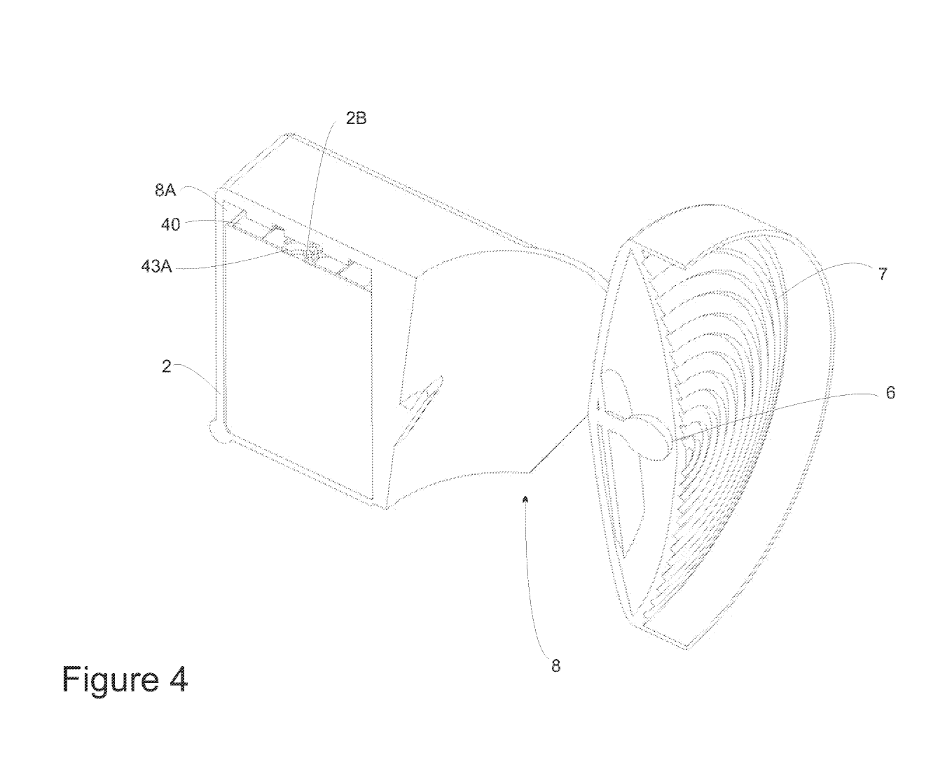

The lantern 1, of a type commonly known in the art, comprises a casing 5 for housing a light source 6 (FIG. 4), e.g. an incandescent bulb or LED. The light source 6 is housed in a front part of the case 5 behind a screen 7 which may also act as a lens, e.g. a Fresnel lens, to improve the lantern's light projection characteristics.

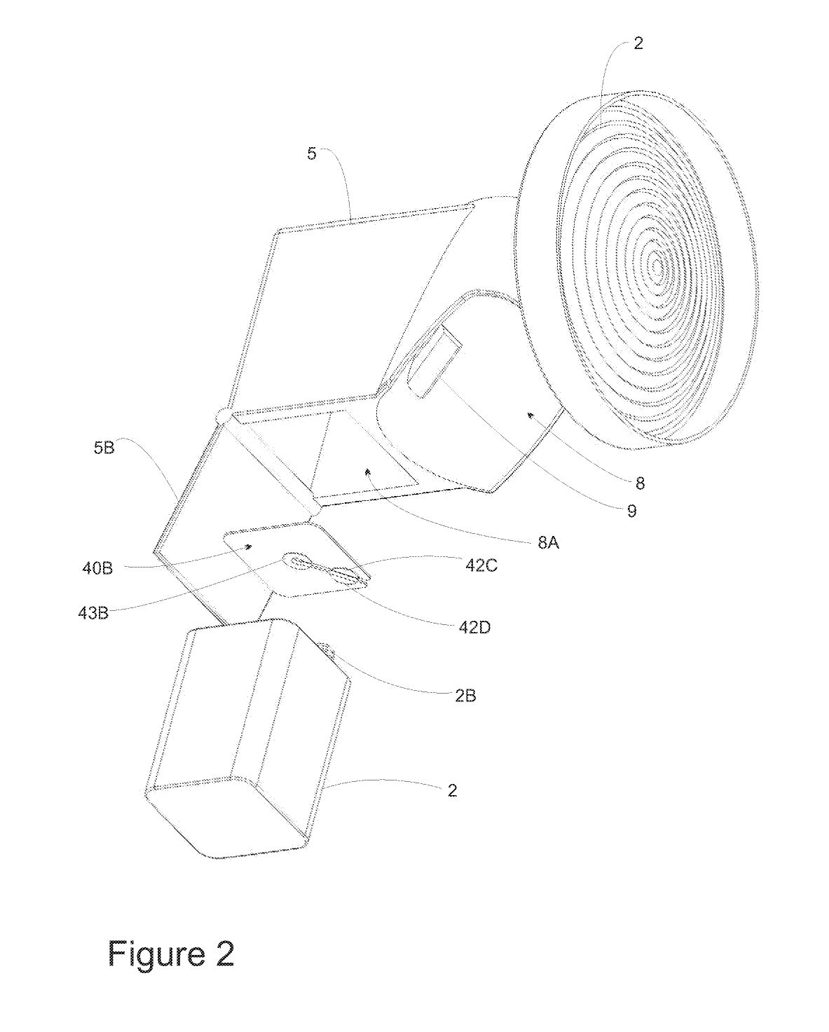

Behind the light source 6, the casing 5 is formed with a cavity 8 shaped to allow the lantern 1 to be placed over and supported upon a traffic cone (not shown). A switch button 9 (FIG. 2) is positioned to extend into the cavity 8 so as to be depressed and activate the light source 6 when the lantern 1 is mounted onto the cone.

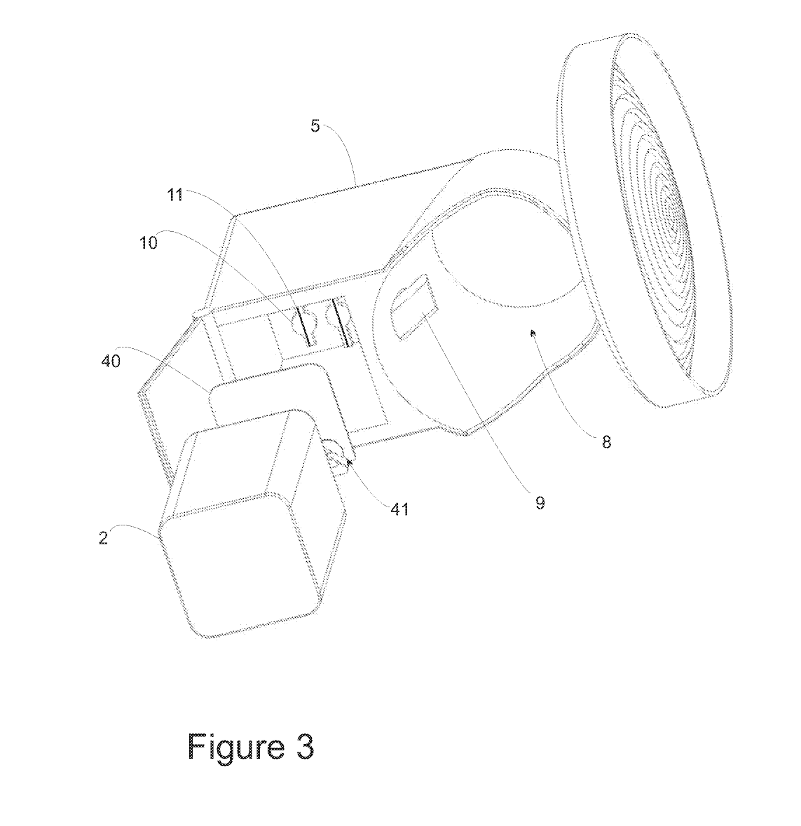

A second cavity forms a battery housing 8A for the lantern battery 2. An inner wall of the housing 8A is formed with a series of plugs 10 (FIG. 3) arranged to receive the coil terminals 2B when the battery 2 is housed in the housing 8A. The plugs 10 are arranged so as to be able to receive the terminals 2B even when the battery is inserted in a variety of orientations. Electrical connection between the battery 2 and the light source 6 is provided by wires 11 which run along the inside end wall of the casing 5, through the base of the plugs 10 and to the light source 6.

A flap 5B hinged to a lower part of the casing 5 can be opened to allow the battery 2 to be placed inside housing 8A, and closed to retain the battery 2 within the housing 8A. The depth of the housing 8A is sized to be slightly smaller than the height of the battery 2 including terminals 2A. This means that when the flap 5B is closed, it presses against the battery causing the spring terminals 2A to be slightly compressed between the top face 2A of the battery 2 and the casing 5. This ensures that the terminals 2A remain in contact within the wires 11, irrespective of the orientation of the lantern 1.

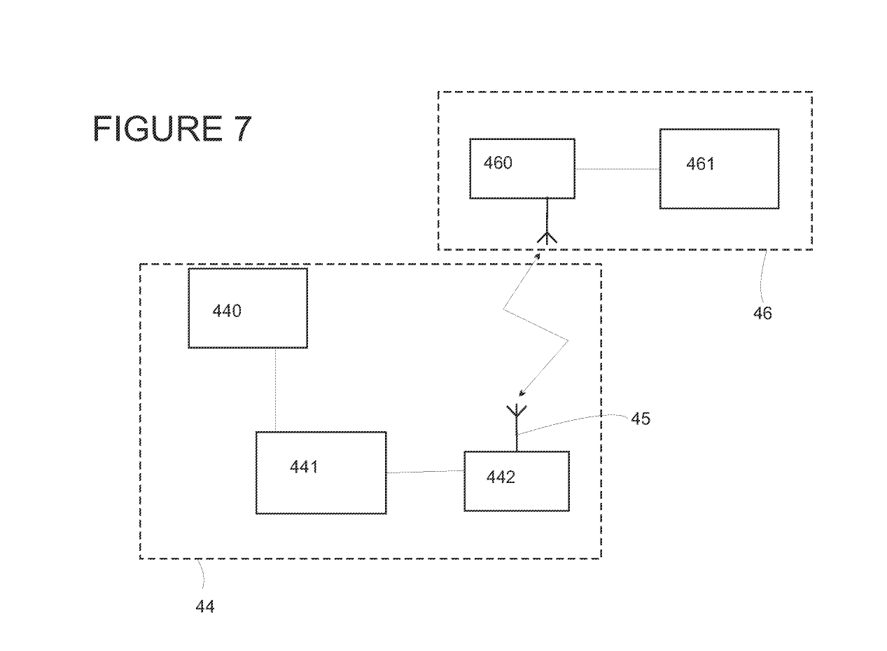

A sensor unit 4, which forms part of a collision warning system, is adapted to be mounted into the lantern 1. The sensor unit 4 comprises a circuit board 40 having circuitry (shown schematically as 44—see FIG. 7) including means 440 to detect when the lantern 1 is knocked over, and in response, to produce a wireless signal to activate an alarm 461 remote to the lantern 1. In order to provide these functions, the circuitry typically comprise an sensor 440 (e.g. an accelerometer) which generates a signal in response to the lantern 1 being tipped, a processor 441 arranged to receive the signal from the sensor 440 and to cause a transmitter 442 to transmit an ‘alert’ signal via an antenna 45 when the signal from the sensor 440 indicates that the lantern 1 has been knocked over.

The collision warning system further comprises an alarm unit 46 comprising an alarm means 461 which can receive the alert signal via receiver 460 and which is activated upon receiving said the alert signal to produce an alarm. The alarm means may comprises an audible alarm such as a horn/siren, though a visual alarm may be used as well/instead. The alarm unit 46 is located remotely from the one or more sensor units 4, proximate in the vicinity of the maintenance workers in order that that alarm may be noticed. In a variant system there may be multiple alarm units positioned in different locations along the perimeter, each being activated upon receiving an alert signal from the sensor units. The alarm unit may take different forms, for example as an in-the-ear device.

The circuitry 44 preferably comprises means to analyze/filter the signal from the sensor 440 in order to distinguish between occasions in which the lantern 1 is caused to vibrate, e.g. by the occurrence of a heavy-good vehicle passing nearby, from when the lantern 1 is tipped/knocked over by an impact with a vehicle. This helps to prevent the alarm being activated falsely.

In addition to the above features, the circuit board 40 defines a slot 41 which extends diagonally inwardly from a corner of the board 40, substantially towards the centre of the board 40.

To provide electrical connection between the sensor unit 4 and the battery 2, the circuit board 40 defines electrical contacts 42, 43 spaced along the slot 41 by a distance substantially equivalent to the spacing between the spring coil terminals 2A of the battery 2.

Electrical contact 42 comprises exposed conductive areas 42A, 42B, 42C and 42D. Conductive areas 42A, 42B are located on a first side of the board 40A, directly adjacent to, and on opposing sides of slot 41. Conductive areas 42C, 42D are arranged at a substantially identical position (i.e. in register) with contacts 42A, 42B on the opposite side 40B of board 40, namely the side facing the battery 2.

Electrical contact 43 surrounds the inner terminus of slot 41, and comprises conductive areas 43A & 43B positioned substantially in register on opposing side of board 40A, 40B.

To assemble the sensor unit 4 and battery 2 into the lantern 1, the sensor unit 4 and battery are arranged as shown in FIG. 3 with the sensor unit 4 above and to one side of the battery 2 such that the axis of slot 41 and battery terminals 2B are aligned. The sensor unit 4 is moved towards the terminals 2A as illustrated by arrow 50 so the wire coil forming the coil of each terminal 2A passes into slot 41. The sensor unit 4 is homed when coils 2B are substantially in register with electrical connectors 42, 43.

Because the board 40 is relatively stiff and slot 41 relatively narrow compared with the diameter of the coil terminals 2B, the above described movement causes a slight extension of the coils 2B. As a result, when the unit 4 is homed, the coils 2B tend to contract, pressing against the sensor unit 4, which helps to secure the unit to the battery 2 and helps to ensure the terminals 2B maintain an electrical connection with contacts 42, 43.

The sensor unit/circuit board 40 is shaped and sized to substantially match or sit within the profile of the top face of the battery from which the terminals 2B extend. The slot 8A is arranged so that when the sensor unit is homed, the sensor substantially sits within the profile of the top face 2A of the battery 2, and thus can fit within the battery housing.

The depth of the sensor unit 4 is less than the height of the battery's coil terminals 2A when compressed within the housing 8A. This means the sensor unit 4 can reside within the space between the top face 2A of the battery and the housing 8A, required to accommodate the projecting terminals 2B.

Once the sensor unit 4 is installed onto the battery terminals 2B, the battery 2 and sensor unit 4 can be placed within the battery housing 8A such that the upper portions of the battery terminal contact the electronic contacts within the housing.

Because the sensor unit 4 is in direct contact with the battery terminals 2B, it can operate as soon as it is installed on the battery 2, and its operation is not affected by the operating condition of switch 9.

Where it is wished to control the operation of the sensor unit independently of the lamp, the sensor unit can be provided with its own switch. Where it is desired that the sensor unit only operates when the lamp is on, the sensor unit may be provided with an electronic switch which operates to activate the sensor unit when a change in the voltage across the battery is detected indicative of an addition power being drawn from the battery.

Once the battery with sensor unit 44 is installed, the lanterns can be deployed onto cones as normal, and will function in the manner described previously.

Other arrangements of the slot 41 are possible. For example, the diagonal slot could be replaced with two parallel slots extending substantially at an angle substantial normal from one edge, or a single broad opening or cut out.

The sensor unit may take forms other than described above, for example it is possible that the alarm unit is incorporated as part of the sensor unit, in which case a wireless transmitter would be unnecessary.

Although it is expected that the sensor will comprise an accelerometer, it is possible that the sensor may take other forms, e.g. a mercury switch, or it may form part of a light gate.

The sensor unit can equally be installed in lanterns which are designed to sit directly on the road rather than on a cone, and therefore may not be adapted with a cavity shaped to sit on a cone.

The casing 5 is typically manufactured from a synthetic plastics material though other materials may be chosen.

It is expected that the sensor unit will be used with lanterns powered by standard lantern batteries which comprise projecting spring coil terminals. Nevertheless, the sensor unit may be used with any lantern suitable for use with road markers, and for example where the projecting terminal is provided by the lantern's electrical contacts rather than by the battery.

The above described sensor unit installation allows a sensor unit to be straightforwardly installed into existing lantern design without modification of the lantern or the battery. Nevertheless, the sensor unit could be incorporated elsewhere within the lantern housing, i.e. not within the cavity for the battery, in such arrangements other provision would need to be made to provide power from the battery to the sensor unit, e.g. an electrical connection between the contacts to the battery and the lamp. In such embodiments it is likely that the sensor unit would be incorporated during manufacture of the lantern. The sensor unit may optionally be incorporated with other circuitry which may already be present in the lantern, e.g. that used to allow a series of lanterns to switch on/off in sequence.

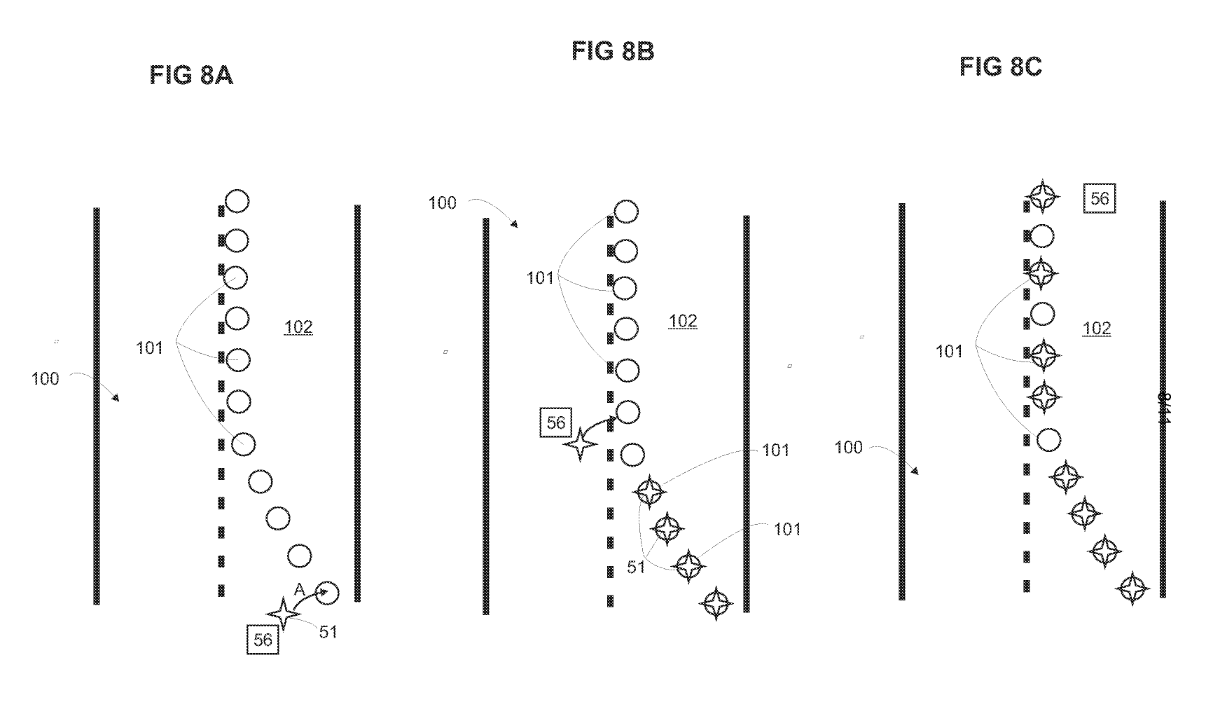

FIG. 8A-8C illustrate a carriageway 100 which has been closed off by a boundary defined by road traffic cones 101 or equivalent markers to create a refuge or work area 102.

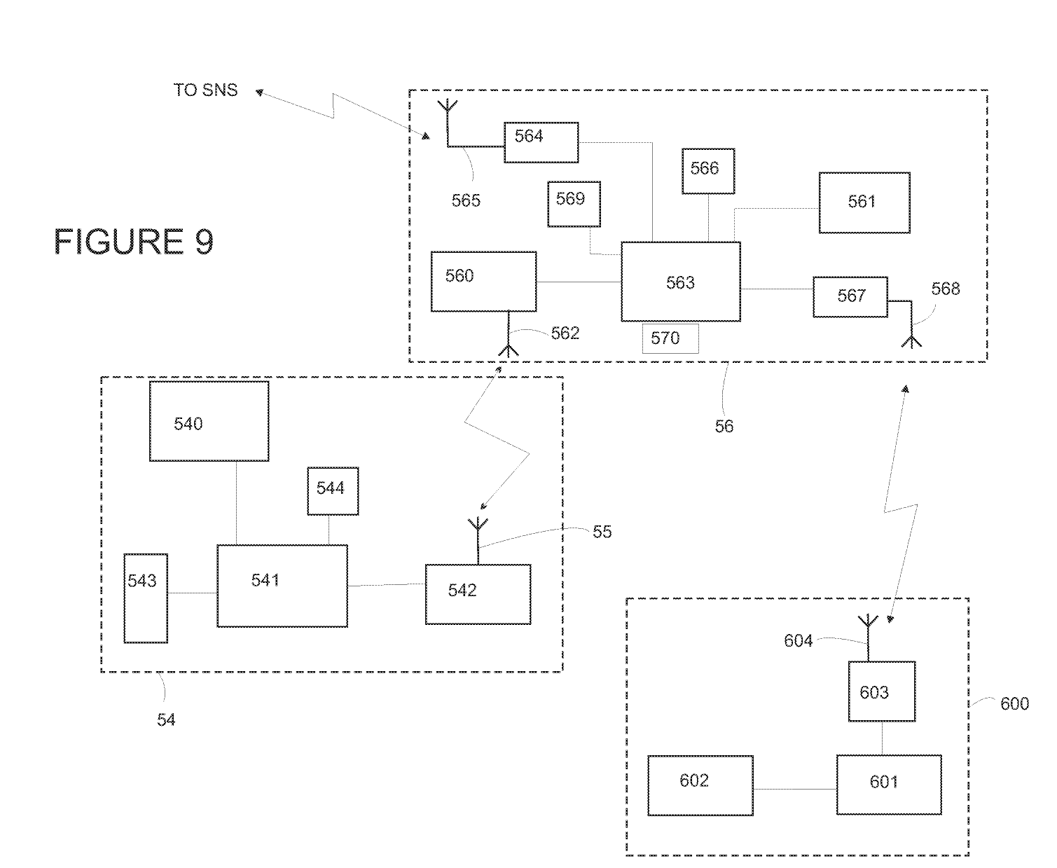

Lanterns 5 comprising sensor units 54 illustrated schematically in FIG. 9 are placed (as illustrated by arrow A) on or around the cones 101.

Sensor unit 54 comprises circuitry and programmed hardware to provide the features and functions described below, the implementation of which will be straightforward to a person skilled in the art in view of the present teaching. The sensor unit 54 comprises a sensor 540 (e.g. an accelerometer) which generates a signal in response to the sensor unit 54 being accelerated e.g. as a result of an impact to the lantern 51; a processor 541 arranged to receive the signal from the sensor 540 and to cause a short range transceiver 542 to transmit an alert signal via an antenna 55 when the signal from the sensor 540 indicates that the lantern 1 has been knocked. Sensor unit 54 further comprises a store 543, typically in the form of non-volatile memory such as EPROM.

An alarm unit 56 is moved along the perimeter so as to be proximate the sensor units 54 as they are deployed (FIGS. 8A & 8B). The alarm unit 56 comprises an alarm generating means 561 such as a horn, transceiver 560, antenna 562, processor 563, store 569, a receiver 564 and associated antenna 565 for receiving position information from a satellite navigation system (SNS) such as GPS.

The alarm unit 56 further comprises a switch 566 to switch the alarm unit 56 between modes of operation, and a further transmitter 567 and antenna 568 for communication to a remote station 600. In practice, some or all of transceiver 560, receiver 564 and transmitter 567 may be provided by one or more transceiver units sharing a common antenna. The above functions are carried out by circuitry including a CPU and memory programmed to carry out these functions, implementation of which will be straightforward to a person skilled in the art in conjunction with the teaching provided herein.

A remote station 600 comprises a computer 601 with a user interface 602, receiver 603 and antenna 604. The role of the remote station 600 will be described later.

Before deployment of the lanterns 1, the alarm unit 56 is switched on. The processor 563 instructs for a connection to be made with the SNS through receiver 564 and antenna 565 to obtain information of the alarm unit's 56 position. This connection is used to maintain up-to-date position information of the alarm unit changes as it moves along the cone perimeter. The position information is held in store 569.

The alarm unit 56 is placed in a deployment mode by means of switch 566. In deployment mode the processor 563 causes a broadcast signal to be continuously or repeatedly emitted through transceiver 560 and antenna 562 to search for deployed sensor units 54.

The alarm unit 56 is moved to or proximate the location of the first lantern 51 (incorporating sensor unit 54) is to be deployed (FIG. 8A).

As the lantern 51 is placed on or near a cone, switch 544 of the sensor unit 54 is activated. This causes the sensor unit 54 to be placed into a deployment mode in which it listens for the broadcast signal from the alarm unit 56. The switch may be the electronic or mechanical switch described earlier in relation to sensor unit 44.

In response to receiving a broadcast signal, the sensor unit 54 transmits an acknowledgement signal.

In response to receiving an acknowledgement signal, the alarm unit 56 sends a further signal transmitting up-to-date position information in store 569. Other information relating to the nature of the alarm signal may also be transmitted such as the channel that the sensor unit should broadcast an alarm signal and/or the identity that the sensor unit should use.

Following this exchange, the sensor unit 54 confirms receipt of the information whereupon it switches to an operational mode to detect an impact and generate an alarm signal in response thereto.

Following receipt by the alarm unit 56 of the sensor unit's confirmation, the alarm unit 56 may generate a visual/audible and/or haptic signal via alert means 561 in order to indicate that the sensor unit 54 has been successfully deployed.

This process is repeated for each lantern 1 with the alarm unit 56 moved along the perimeter as the lanterns are deployed.

In practice, it is expected that the alarm unit 56 will probably be carried on the vehicle with the lanterns 51 to be deployed. It is therefore likely that some sensor units 54 will be provided with the same position information as at times it is likely that the van will be stationery during deployment of several lanterns 51 on nearby cones. This could be avoided by moving the alarm unit 56 by hand nearer to each deployed lantern 51, however, it is not expected that this level of accuracy will be necessary, and that a general location of the sensor units 54 will be sufficient.

Once all of the lanterns 1 have been deployed, the alarm unit 56 is positioned in/the vicinity of the worker operating in area 102 (FIG. 8C). The alarm unit 56 is switched using switch 544 to an alarm mode, in which it listens for alarm signals transmitted by the sensor units 54 and causes the alarm generating means 561 to produce an alarm, e.g. a siren visual notification in response thereto which warns the workers that a vehicle may have entered the work area 102.

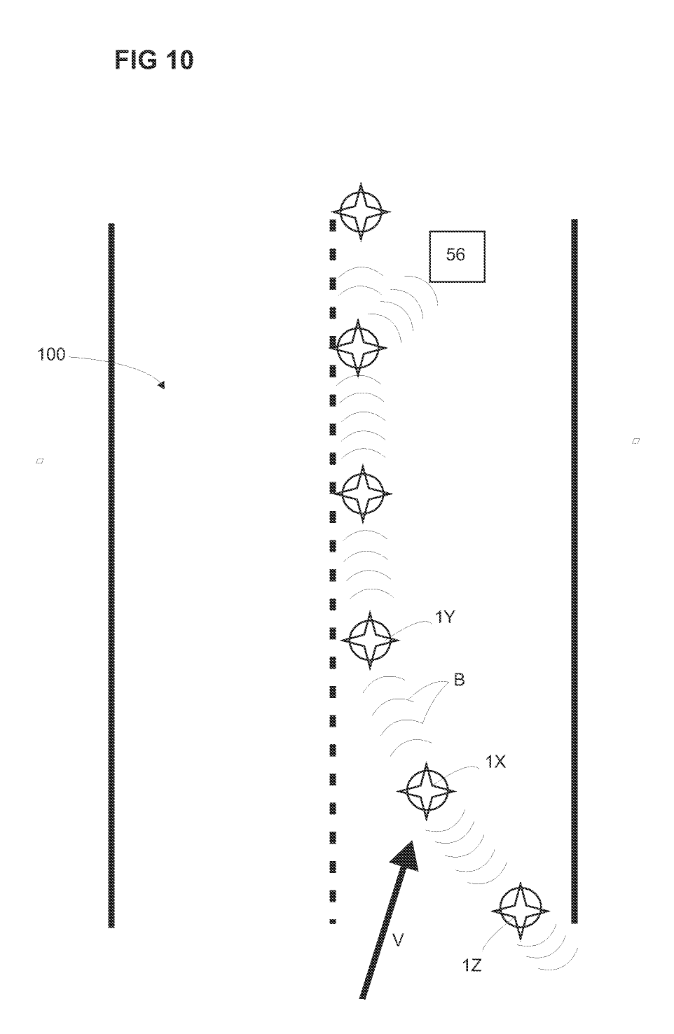

FIG. 10 illustrates a situation in which a cone 101 having a lantern 1X thereon is knocked over by a motor vehicle represented by arrow V. The accelerometer 541 detects that the sensor unit 54 has be tipped or moved and generates a signal which is received by processor 541. In response the processor 541 causes the transmitter 542 to emit an alarm signal and to transmit the position information in store 544.

The alarm signal shown schematically by lines B (in practice the signal will be non-directional) is received by sensor units 54 in neighboring lanterns 1Y 1Z, through their respective transceivers. In response to this received signal the neighboring sensor units 54 rebroadcast the received signal through their own transceivers 542.

The signal is repeatedly received and retransmitted by sensor unit 54 in lanterns 1 along the perimeter. In this manner, the transmit power of the transceivers 542 of each sensor unit 54 can be kept low so as to conserve battery life, whilst still allowing an alert signal from any sensor unit 54 along the perimeter to be received by the alarm unit 56.

In order to prevent the same alarm signal being repeatedly sent to and fro between neighboring sensor units 54, the sensor units 54 are programmed to become unresponsive to alarm signals received from other sensor units 54 for a short period after forwarding an alert signal.

Preferably, the sensor units 54 use the position information (or identifier) associated with the alarm signal to discriminate between an alarm signal which has been previously forwarded from a ‘new’ alarm signal emanating from a different sensor unit. This means that where multiple cones are knocked over, the alarm unit will receive an alarm signal for each disrupted sensor unit.

Upon receiving an alarm signal the processor 563 of the alarm unit 56 causes the alarm generating means 561 to generate an alarm. It also causes a signal to be transmitted via transmitter 567 to the remote station 600. The connection between the alarm unit and the remote station may be provided through a cellular network e.g. GSM, the internet, or a combination thereof.

A program run on computer 601 is effective upon receipt of the signal from transmitter 567 to generate an alarm for the user of the computer through the user interface 602. For example, the program may be arranged to display a map and uses the position information sent with the alert signal to display the position of the affected cone on the map.

As well as sending the signal to a remote station 600, the alarm could also be used to generate other alerts, e.g. by text message, to relevant persons tasked to manage the road works.

In addition or as an alternative, an entry relating to the alert may be created and stored on a database for auditing purposes. The entry may include information such as the time of the alert, the position of the sensor unit, and identity of the sensor unit.

The above described system makes it possible to remotely manage road works from a central control. When it is noted that cone as been knocked over, a patrol can be dispatch to the position provided in the alert. This reduces the frequency, or possibly the need entirely for patrolling of road works areas.

In a simplified version of the above embodiment, the alarm/location unit transmits is own position information over transmitter 567. This obviates the need to provide or associate the sensor units with position information. This curtailed system is less able to provide accurate position information of a breach, though this may be sufficient however, where it is only necessary to know that there is a breach in the perimeter or where there are multiple alarm units are spaced along perimeter arranged to receive alarm signal from nearby sensor units.

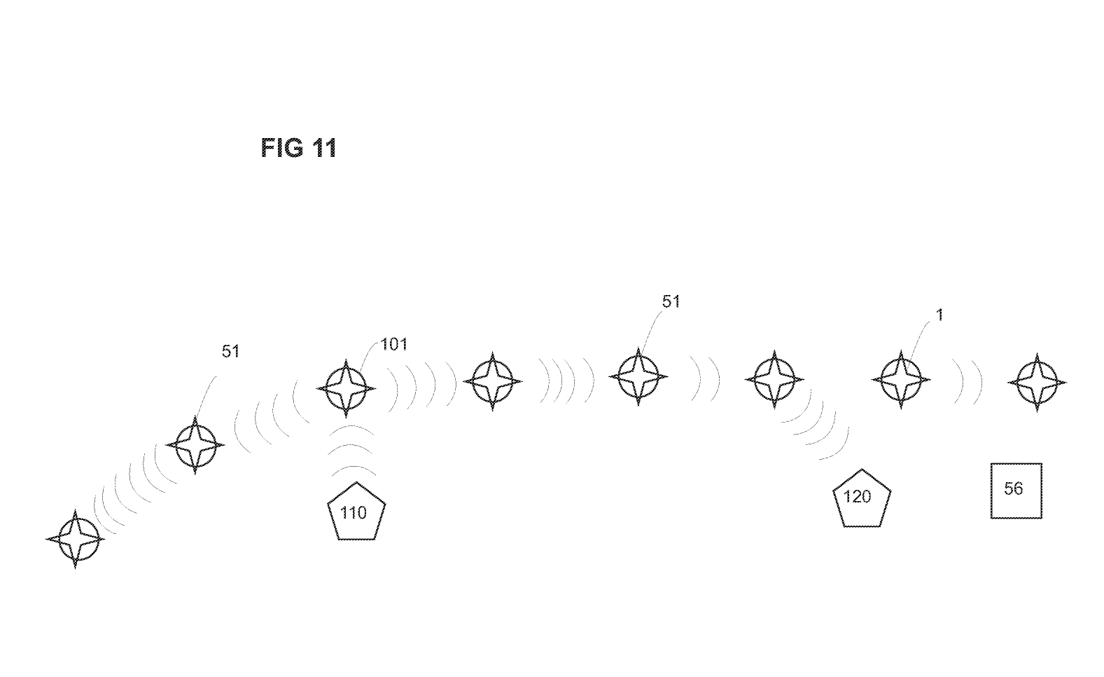

It has been realized that a series of deployed sensor units 54 along a perimeter may be used, in effect, as a conduit or network for carrying other information along the perimeter. FIG. 11 illustrates a series cones 101 having mounted thereon lanterns 51 incorporating sensor units 54 arranged along a perimeter, and an auxiliary unit 110 (not forming part of the perimeter breach alarm system) which might be, for example: a sensor worn by an operator, e.g. to sense heart rate breathing etc; or a pollution monitor e.g. for sensing carbon monoxide or nitrogen dioxide. Alternatively the auxiliary unit 110 may not have a sensor but provide another function, e.g. as a panic alarm to be worn by an operator or as a location tag.

The auxiliary unit 110 is positioned somewhere in the vicinity of the perimeter. Where the auxiliary unit 110 comprises a sensor, it may continuously or periodically transmit signals which are received by the closest sensor unit(s) 54, which receive the signal through transceiver 542 and then retransmit the signal in a similar manner described for relaying alert signals. In a variant embodiment, the sensor unit 54 receiving a signal from unit 110, identifying that the signal does not emanate from another sensor unit 54 relays the signal together with information identifying itself e.g. with the identifier provided by the alarm unit 56 and/or position information. The augmented signal is then relayed along the perimeter by the other sensor units 54 to a receiver unit 120. The receiver unit 120, for example, may function to provide an alarm, relay the information over a longer range connection, e.g. cellular network or internet, and or store the information for auditing or other purposes.

In a further variation, the auxiliary unit 110 is arranged to transmit a return signal in response to a signal received from the receiver unit 120 through the perimeter network.

The return signal is forwarded back along the perimeter by the sensor units 54, together with position information of the sensor unit 54 which first received the return signal from the auxiliary unit 110. This information can be used to identify the approximate position of the auxiliary unit 110. The auxiliary unit 110 may be mounted onto equipment or people and used to identify the location or track the movement thereof. Further alternatively the units 110, 120 may be arranged to continuously or periodically transmit a signal which is received by which ever sensor unit 54 is closest and thereby used to track movement.

Although in the above examples the sensor units 54 are incorporated into lanterns 51, this does not have to be the case, and could instead be incorporated into the cone 101 or other marker element.

The perimeter breach system may also be used in applications other than roadside perimeters formed of cones or markers. For example it may be used to provide an alert of intrudes into a restricted or private site, such as a building site. In such an arrangement, the sensor units may be arranged to be supported (directly or otherwise) on the perimeter fencing, wall or other barrier. Where the perimeter is fencing, the sensor could detect when the fencing is caused to move by being climbed upon by an intruder.

The features associated with the alarm unit 56 to obtain and provide positioning information to the alarm units, may equally be provided by a separate unit discreet from the alarm unit.

Although the present specification may describe components and functions implemented in the embodiments with reference to particular standards and protocols, the disclosure is not limited to such standards and protocols. Each of the standards represent examples of the state of the art. Such standards are from time-to-time superseded by equivalents that may be faster or more efficient, but having essentially the same structures and/or functions.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

What is claimed is:

1. A lantern for use as a boundary marker and/or with a road marker, the lantern comprising:
a light source;
a sensor operable whilst the light source is operating to detect when the lantern has been impacted; and
signal generation means to generate an alert signal in response to the detected impact; and
wherein the sensor and signal generation means are arranged to be powered by a battery used to power the light source.

2. A lantern according to claim 1 having a sensor unit which comprises the sensor and the signal generating means; the sensor unit being held within a cavity of a casing of the lantern for holding the battery.

3. A lantern according to claim 2 wherein the lantern comprises electrical conducting means to provide electrical connection between the battery and the light source, and that the sensor unit is supported against the terminals of the battery and/or the electrical conducting means.

4. A lantern according to claim 2 wherein the sensor unit comprises an aperture and/or recess into/through which extends a battery terminal and/or the conducting means.

5. A lantern according to claim 4 wherein the sensor unit comprises electrical contacts arranged adjacent to the aperture so as to make an electrical connection with the conducting means and/or at least one terminal of the battery extending through the aperture.

6. A lantern according to claim 5 wherein the electrical contacts are arranged on either side of the aperture.

7. A lantern according to claim 5 wherein the electrical contacts are provided on opposing faces of the sensor unit.

8. A lantern according to claim 1 wherein the sensor unit is mounted to at least one terminal of a battery.

9. A lantern according to claim 8 wherein the terminals of the battery comprise spring wire coils.

10. A lantern according to claim 7 wherein the aperture/recess comprises a slot which extends inwardly from an outer edge of the sensor unit.

11. A lantern according to claim 10 wherein the slot extends diagonally inwards from a corner edge of the sensor unit.

12. A lantern according to claim 4 wherein the sensor unit comprises a printed circuit board and the aperture/recess is formed in the printed circuit board.

13. A lantern according to claim 1 wherein the alert signal is a broadcast via a radio or microwave transmission.

14. A lantern according claim 1 wherein the sensor comprises an accelerometer.

15. A lantern according to claim 1 adapted to be supported over a traffic cone.

16-25. (canceled)

26. A perimeter breach alarm system comprising multiple sensor units located at positions along a perimeter; each sensor unit having a sensor to detect when the perimeter proximate that sensor unit has been breached and to produce a signal indicative thereof; means to receive the signal from the sensor and to generate a wireless alarm signal; and
an alarm unit adapted to receive the wireless alarm signal from one or more of the sensor units and in response to receiving the wireless alarm signal, to produce an audible or visual alarm.

27. A perimeter breach alarm system according to claim 26 wherein the system also comprises a long range transmitter unit, as compared to the sensor units, arranged to transmit a long range signal upon receipt of the alarm signal from a sensor unit.

28. A perimeter breach alarm system according to claim 27 wherein the long range signal includes the identity and/or position information of the sensor unit which emitted the wireless alarm signal; and/or the identity or position information of the long range transmitter and/or alarm unit.

29. A perimeter breach alarm system according to claim 26 wherein each sensor unit is provided with a unique identifier and/or position information pertaining to its location about the perimeter and the sensor unit sends the unique identifier and/or position information in response to a detected breach.

30. A method of transmitting data between a first unit and a second unit spaced remotely at positions about a boundary perimeter, comprising:
providing a perimeter breach alarm system comprising multiple sensor units spaced about the perimeter comprising: a sensor for detecting that the perimeter proximate the sensor unit has been breached and signal generation means responsive upon said detection to transmit an alert signal;
transmitting the data from the first unit to a sensor unit which is proximate the first unit;
relaying the data between sensor units along the perimeter; and
transmitting the relayed data from a sensor unit to the second unit.

31-37. (canceled)
